(19) United States
(12) Patent Application Publication
(10) Pub. No.: US 2011/0254785 A1
(43) Pub. Date: Oct. 20, 2011

(54) SYSTEM AND METHOD FOR ENABLING MULTIPLE-POINT ACTIONS BASED ON SINGLE-POINT DETECTION PANEL

(75) Inventor: Chun-Hsien Li, New Taipei City (TW)

(73) Assignee: QISDA CORPORATION, Taoyuan (TW)

(21) Appl. No.: 13/082,363

(22) Filed: Apr. 7, 2011

(30) Foreign Application Priority Data
Apr. 14, 2010 (TW) 099111521

(51) Int. Cl. G06F 3/041

(52) U.S. Cl. 345/173

(57) ABSTRACT

A touch panel system comprising a single-point detection panel, responsive to a touch action, for outputting a signal; and a processor for processing the signal to determine a location on said single-point detection panel on which said touch action is manipulated; wherein the processor, based on an algorithm, within a predetermined time interval, detects the variation of said location to judge whether the touch action on the panel is a single-point touch or multiple-point touch.

### CROSS-REFERENCE TO RELATED APPLICATION

This utility application claims priority to Taiwan Application Serial 099111521, filed Apr. 14, 2010, which is incorporated herein by reference.

### BACKGROUND OF THE INVENTION

1. Field of the Invention

The invention relates to a touch panel apparatus, and in particular, to a system and method, based on a single-point detection panel, for performing multiple-point actions made by users.

2. Description of the Prior Art

The touch panel apparatus in recent years has been a popular input apparatus in many different fields. For instances, in the fields of mobile phones, digital cameras, ATMs, kiosks or automobile electronics, the touch panels have found their applications nowadays.

In the state of arts, based on classification of touch point(s), the touch panel apparatuses are categorized into single-point and two-point (multiple-point) touch panel apparatus. The single-point touch panel apparatus employs single-point detection panel and the two-point (multiple-point) touch panel apparatus employs multiple-point detection panel which is more complicated than the single-point detection panel in hardware. As to the classification of modes of detection, the touch panel apparatuses are categorized into the resistive-type, the capacitive-type and the optical-type.

In general, four-wire (xᵢ, xₒ, yᵢ, yₒ) resistive-type single-point touch panel apparatus is lowest in regard to the cost compared with other conventional approaches, wherein (xᵢ, xₒ) represents two electrodes measuring location coordinate in x direction, (yᵢ, yₒ) represents two electrodes measuring location coordinate in y direction. With respect to the cost, current multiple-point or two-point detection panel is much higher than the single-point detection panel.

Currently, since its inherent limitations of the hardware, the single-point detection panel can only be utilized in less-complicated applications and therefore can not detect multiple-point actions of users which are more complicated than single-point touch actions.

Therefore, there is a need in the market for a system and method which can perform multiple-point actions detection based on single-point detection panel.

### SUMMARY OF THE INVENTION

A main objective of invention is to provide a system and method which allow the users to selectively input single-point and multiple-point (or two-point) actions through a single-point detection panel.

The other objective of invention is to promote the functions of single-point detection panel by the system and method disclosed.

To achieve the above mentioned objectives, the touch panel system of the invention is provided, comprising:

a single-point detection panel outputting a signal responsive to a touch action; and

a processor processing the signal for judging a location of the single-point detection panel on which the touch action is performed;

wherein the processor, based on an algorithm, detects a variation of locations within a predetermined time interval, to judge whether the touch action is a single-point touch or a multiple-point touch action.

In addition to the touch pane system, the method is provided for detecting multiple-point touch based on a single-point detection panel outputting a signal responsive to a touch action, comprising:

processing the signal to determine a location of the single-point detection panel on which the touch action is performed; and

detecting a change of the location within a predetermined time interval, based on an algorithm, to judge whether the touch action is a single-point touch or a multiple-point touch.

The above summary of the embodiments does not intend to cover all possible variations or alterations or every aspects of the present invention.

Under the core inventive spirit recited above, more specific embodiments can be contrived.

### BRIEF DESCRIPTION OF THE APPENDED DRAWINGS

Each illustrated embodiment of the present invention will be fully understood with reference to the following description in details and the attached drawings.

FIG. 1 discloses a touch panel system according to the embodiment of the invention.

FIGS. 2a ` 2b discloses the detected touch-point on single-point detection panel and judgment result of processor in 1^{st} example;

FIGS. 3a ` 3b discloses the detected touch-point variation on single-point detection panel and the judgment result of processor in 2^{nd} example;

FIGS. 4a ` 4b discloses the detected touch-point variation on single-point detection panel and the judgment result of processor in 3^{rd} example;

FIGS. 5a ` 5b discloses the detected touch-point variation on single-point detection panel and the judgment result of processor in 4^{th} example;

FIGS. 6a ` 6b discloses the detected touch-point variation on single-point detection panel and the judgment result of processor in 5^{th} example;

FIGS. 7a ` 7b ` 7c discloses the detected touch-point variation on single-point detection panel and the judgment result of processor in 6^{th} example;

FIGS. 8a ` 8b discloses the detected touch-point variation on single-point detection panel and the judgment result of processor in 7^{th} example.

### DETAILED DESCRIPTION OF THE INVENTION

The following exemplary embodiments of the present invention will be further described with reference to the attached drawings. While the present invention has been described with reference to exemplary embodiments, it is understood that various changes and modifications may be made and the invention is not limited to the disclosed exemplary embodiments that are use to enable persons skilled in the art to practice the present invention.

Due to the hardware restriction of single-point detection panel, as users perform two (and more than two) points touch action over the detection panel, the depressed area caused on the panel is different from that caused by one-point touch action. As a result, the electric properties measured from the single-point detection panel respectively for one-point and two-point touch actions will be different from each other. Based on this characteristic together with measurements of touch location, this invention provides a method and touch panel system for realizing objectives of the invention. It is noted that when more than two points are touched substantially at the same time on the single-point detection panel, it detects a balanced location among the points touched.

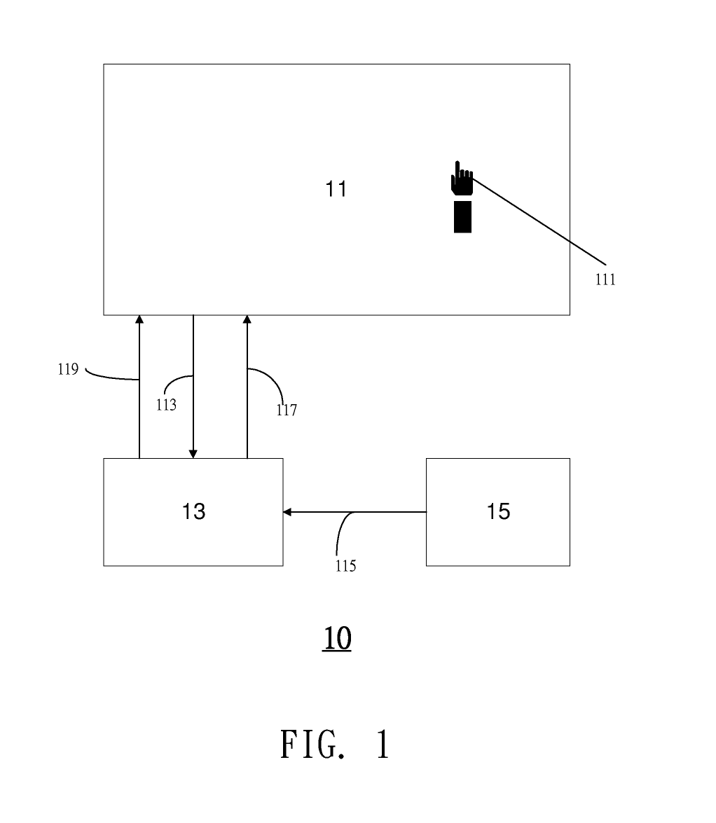

As shown in FIG. 1, other than some conventional elements, the touch panel system 10 of the embodiment of invention, which employs a single-point detection panel for performing at least two points touch action, includes a processor 13 for outputting a scan signal 119 and a single-point detection panel 11 having two membranes contacting with each other responsive to a touch action 111. In response to the scan signal 119, the single-point detection panel 11 outputs a signal 113 corresponding to the touch action 111.

The processor 13 processes the signal 113 in order to determine the location (x, y) of single-point detection panel on which the touch action is performed, and based on an algorithm 15, detects the variation of location (x, y) within a predetermined time interval to judge whether the touch action is a single-point touch or a multiple-point touch. It is observed that when more than two points are touched substantially at the same time on the single-point detection panel, the processor 13 detects a balanced location among the points touched. For a single-point touch, the detected balanced location is identical to the physical location on which the users touch. In this embodiment, the algorithm 15, via the signal 115, is transmitted to the processor 13, but in other possible embodiment, the algorithm 15 may be stored directly in the processor 13. In other words, the touch panel system 10, which is capable of performing at least two points touch action by the single-point detection panel 11, may enter a mode for at least two points touch action from another mode for one-point touch action, responsive to users' touch action 111 of more than one point. While entering the mode for at least two points touch action, a predetermined function corresponding to this more than one point touch action 111 is activated. The signal 117 is a signal from the processor 13 which instructs the display to execute specific display function. In the embodiment, the display is integrated with the single-point detection panel 11, and however, other alternatives are possible.

Under the configuration of embodiment shown in FIG. 1, in some embodiments, the single-point detection panel 11 is a capacitive-type detection panel. And in some embodiments, the single-point detection panel 11 is a 4-wired resistive-type detection panel.

Under the configuration of embodiment shown in FIG. 1, in some embodiments, the processor 13 may detect static touch action and/or dynamic (transient) touch action of more than two points (included). The term of dynamic (transient) means variable variation with respect to time.

Under the configuration of embodiment shown in FIG. 1, in some embodiments, the processor 13 may perform cross-scan operation through the signal 119 to the single-point detection panel 11 (for example, scanning (xi, yi) and measuring (xo, yo)) for detecting an area parameter corresponding to the area of single-point detection panel 11 which is influenced by the touch action 111. As the single-point detection panel 11 is a resistive-type detection panel, the area parameter might be in form of resistive value or unitless value (i.e., no unit). As the single-point detection panel 11 is a capacitive-type detection panel, the area parameter might be in form of capacitance value or unitless value (i.e., no unit). Therefore, the processor 13, responsive to the transient variation of area parameter value, performs specific judgment or activates a corresponding function. To different kinds of single-point detection panel, how to calculate or obtain the area parameter is well known technique and is therefore not described in detail herein.

After the processor 13 outputs the scan signal 119 to the single-point detection panel 11, it receives the signal 113 from the single-point detection panel 11 to calculate the area parameter and judge whether the touch action 111 is a single-point touch or multiple-point touch, based on the calculated area parameter. Taking the resistive-type detection panel as an example, but not restriction, typically, the area parameter is inversely proportional to the area of detection panel influenced by the touch action 111.

According to one embodiment, as the area parameter falls within a predetermined level range, the processor 13 judges the touch action 111 is a multiple-point touch; otherwise, the processor 13 judges the touch action 111 is a single-point touch. In one embodiment, the entire range of area parameter is 0-1000. The embodiment of predetermined level range of area parameter is 0-200 for the multiple-point touch. As the value of area parameter falls within 200-1000, the processor 13 judges the touch action 111 is a single-point touch.

TABLE 1
(example 1)

| ti | t1 | t2 | t3 | t . . . | t . . . | tn-1 | tn |
|---|---|---|---|---|---|---|---|
| Xti | 50 | 52 | . . . | . . . | . . . | 49 | 48 |
| Yti | 50 | 51 | . . . | . . . | . . . | 51 | 52 |

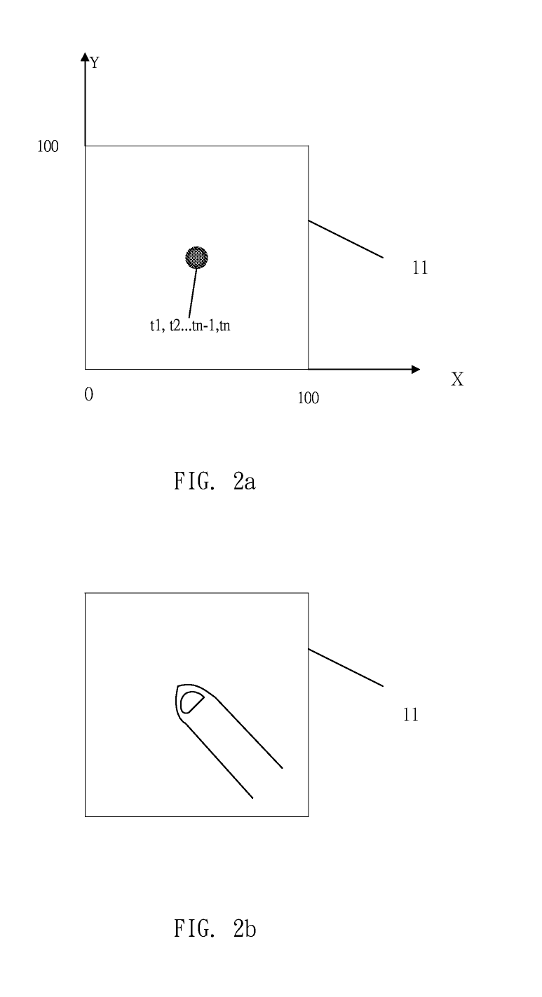

The table 1 above shows (x, y) values detected by the processor 13 within a predetermined time interval for example 1, and corresponding FIG. 2a, 2b respectively shows the detected touch-point on the single-point detection panel 11 and the judgment result of processor 13 according to algorithm 15. In details, as the processor 13 detects the values of table 1 during interval t1-tn (for instance about 40-50 milli-sec), the processor 13 judges this is a single-point touch action, shown in FIG. 2b, since all detected values remain substantially unchanged.

TABLE 2
(example 2)

| ti | t1 | t2 | t3 | . . . | . . . | tn-1 | tn |
|---|---|---|---|---|---|---|---|
| Xti | 20 | 90 | 26 | . . . | . . . | 65 | 50 |
| Yti | 20 | 90 | 25 | . . . | . . . | 63 | 50 |

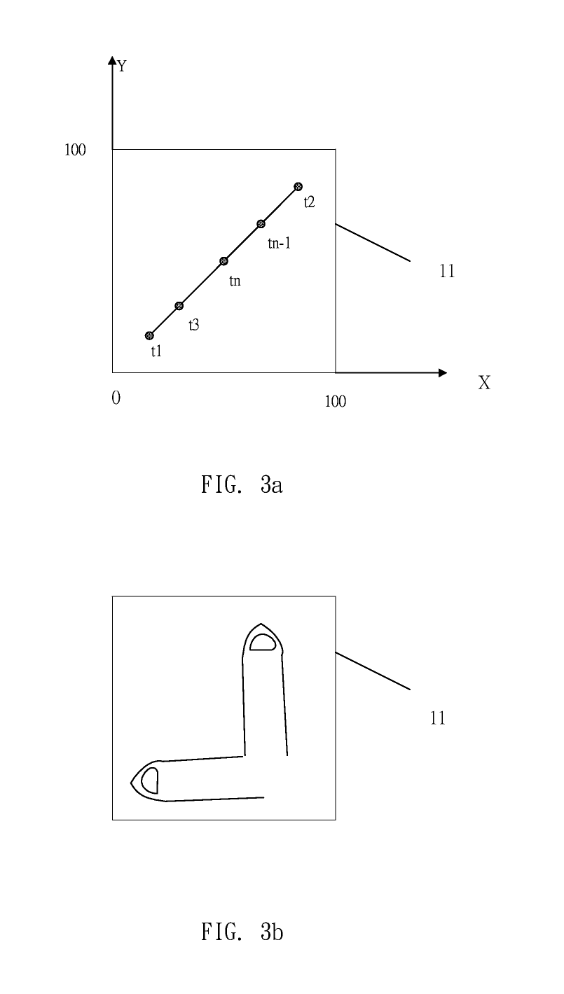

The table 2 above shows (x, y) values detected by the processor 13 within a predetermined time interval for example 2, and corresponding FIG. 3a, 3b respectively shows the detected touch-point variation on the single-point detection panel 11 and the judgment result of processor 13 according to algorithm 15. In details, as the processor 13 detects the values of table 2 during interval t1-tn (for instance about 40-50 milli-sec) that fluctuate in a region indicated in FIG. 3a, the processor 13 judges this is a multiple-point touch action, shown in FIG. 3b.

As the region is substantially a straight line as indicated in FIG. 3a, the processor 13 judges the multiple-point touch is actually a two-point touch. To determine whether the region is a straight line, it is required to calculate all slope values of connected lines between those detected points within the predetermined time interval and determine whether they are substantially equal to each other. Since all slope values of connected lines between those detected points in table 2 are substantially the same, the region is determined to be a straight line.

TABLE 3
(example 3)

| ti | t1 | t2 | t3 | t4 | t5 | . . . | tn |
|---|---|---|---|---|---|---|---|
| Xti | 52 | 30 | 50 | 75 | 46 | 30 ≦ Xti ≦ 75 | 30 ≦ Xti ≦ 75 |
| Yti | 90 | 29 | 61 | 27 | 43 | 27 ≦ Yti ≦ 90 | 27 ≦ Yti ≦ 90 |

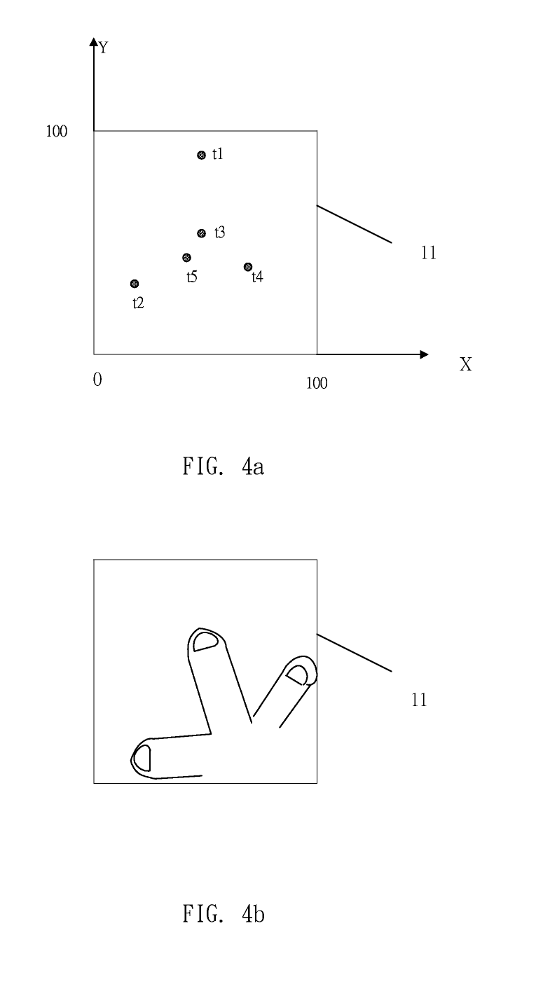

The table 3 above shows (x, y) values detected by the processor 13 within a predetermined time interval for example 3, and corresponding FIG. 4a, 4b respectively shows the detected touch-point variation on the single-point detection panel 11 and the judgment result of processor 13 according to algorithm 15. In details, as the processor 13 detects the values of table 3 during interval t1-tn (for instance about 40-50 milli-sec) that vary within a region indicated in FIG. 4a, the processor 13 judges this is a multiple-point touch action, shown in FIG. 4b.

As the detected region is substantially a polygon, the processor 13 judges the multiple-point touch is at least a three-point touch action. As to what kind of polygon is involved by the touch action, observation must be made by the algorithm 15 to the variation range of (Xti, Yti) within predetermined time interval for obtaining a conclusion. For instance, with (Xti, Yti, 1≦i≦n) values in table 3, the processor 13 observes a phenomenon of 30≦Xti≦75 and 27≦Yti≦90, and the detected balanced locations of all (Xti, Yti) are within the triangle formed by (Xt1, Yt1), (Xt2, Yt2) and (Xt4, Yt4). Therefore the processor 13 judges this is a three-point touch action.

TABLE 4
(example 4)

| ti | t1 | t2 | t3 | t4 | t5 | t6 | tn |
|---|---|---|---|---|---|---|---|
| Xti | 40 | 60 | 75 | 20 | 94 | 18 | . . . |
| Yti | 25 | 25 | 27 | 25 | 23 | 25 | . . . |
| Ati | 420 | 185 | 170 | 158 | 143 | 116 | . . . |

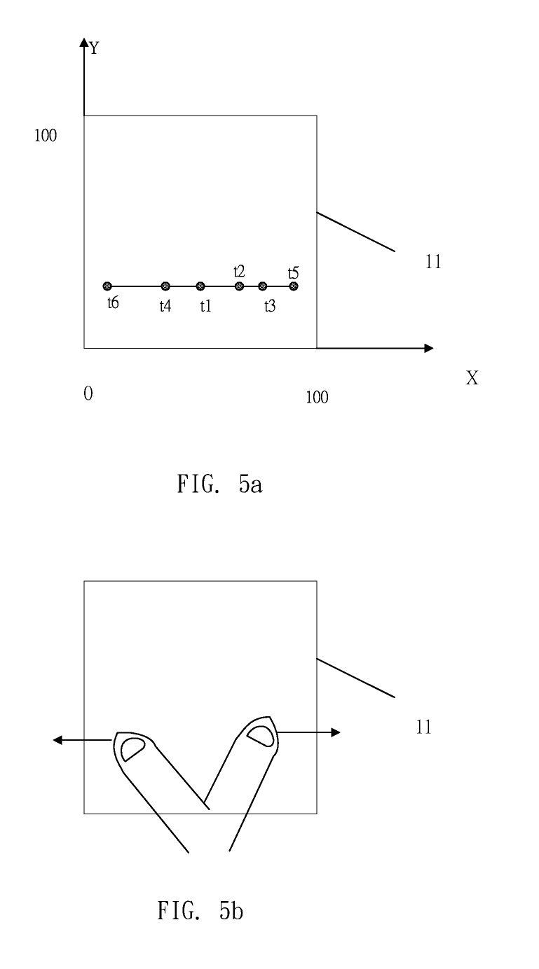

The table 4 above shows (x, y, A) values detected by the processor 13 within a predetermined time interval for example 4, and corresponding FIG. 5a, 5b respectively shows the detected touch-point variation on the single-point detection panel 11 and the judgment result of processor 13 according to algorithm 15. Ati is the area parameter with respect to the touch area at time ti. As described above, in one embodiment, the range of area parameter is 0-1000, and corresponding embodiment to the multiple-point touch for predetermined level range of area parameter is 0-200. As the detected value of area parameter is about 200-1000, the processor 13 judges the touch action 111 is a single-point touch. In details, as the processor 13 detects values in table 4 within predetermined time interval (about 40-50 milli-sec), the processor 13 judges this is a multiple-point touch and the touch points depart from each other gradually as indicated in FIG. 5b. This is because the processor 13 detects the locations vary substantially along a straight line and the area parameter Ati continuously falls within the predetermined level range (e.g., smaller than about 200, except the initial one) and Ati values for area parameter gradually decreases within the predetermined time interval. The locations substantially varying along a straight line implies a two-point touch action, and Ati values continuously falling within the predetermined level range also confirms the two-point touch, and gradually decreasing Ati values indicating the influenced area of single-point detection panel 11 is increasing indicating the two points depart from each other. As a result, the processor 13 judges the multiple-point touch is a two-point touch and these points gradually depart from each other.

TABLE 5
(example 5)

| ti | t1 | t2 | t3 | t4 | t5 | . . . | tn |
|---|---|---|---|---|---|---|---|
| Xti | 80 | 40 | 70 | 52 | 60 | . . . | . . . |
| Yti | 80 | 40 | 69 | 50 | 60 | . . . | . . . |
| Ati | 136 | 142 | 147 | 151 | 176 | . . . | . . . |

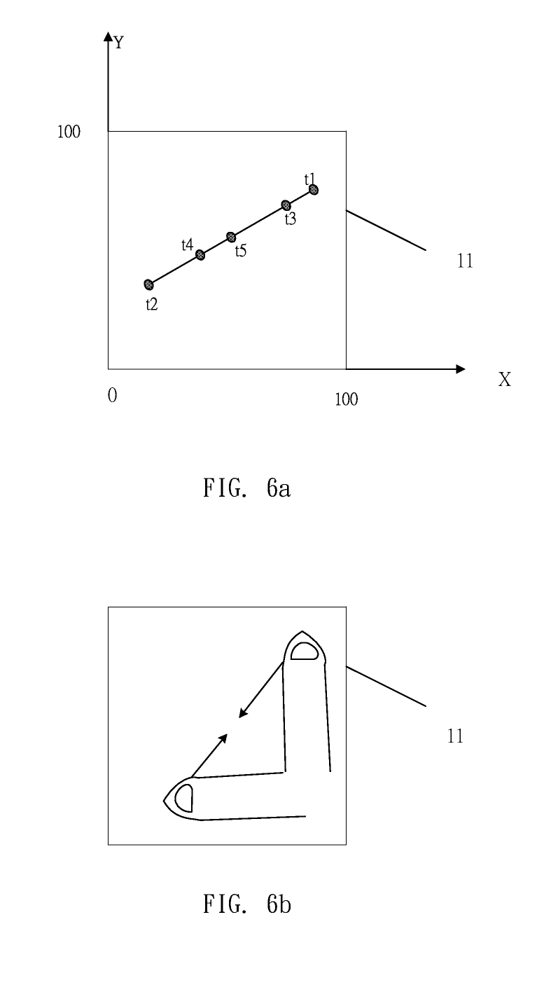

The table 5 above shows (x, y, A) values detected by the processor 13 within a predetermined time interval for example 5, and corresponding FIG. 6a, 6b respectively shows the detected touch-point variation on the single-point detection panel 11 and the judgment result of processor 13 according to algorithm 15. In details, as the processor 13 detects values in table 5 within predetermined time interval (about 40-50 milli-sec), the processor 13 judges this is a multiple-point touch and the points approach each other gradually as indicated in FIG. 6b. This is because the processor 13 detects the locations vary substantially along a straight line and the area parameter Ati continuously falls within the predetermined level range (e.g., smaller than about 200) and Ati values for area parameter gradually increases within the predetermined time interval. The locations substantially varying along a straight line implies a two-point touch action, and Ati values continuously falling within the predetermined level range also confirms the two-point touch, and gradually increasing Ati values indicating the influenced area of single-point detection panel 11 is decreasing indicates the two points approach each other. As a result, the processor 13 judges the multiple-point touch is a two-point touch and these points gradually approach each other.

TABLE 6
(example 6)

| ti | t1 | t2 | t3 | t4 | t5 | t6 | t7 |
|---|---|---|---|---|---|---|---|
| Xti | 13 | 13 | 12 | 13 | 15 | 13 | 13 |
| Yti | 31 | 74 | 39 | 68 | 50 | 45 | 82 |
| Ati | 84 | 98 | 112 | 145 | 167 | 192 | 768 |

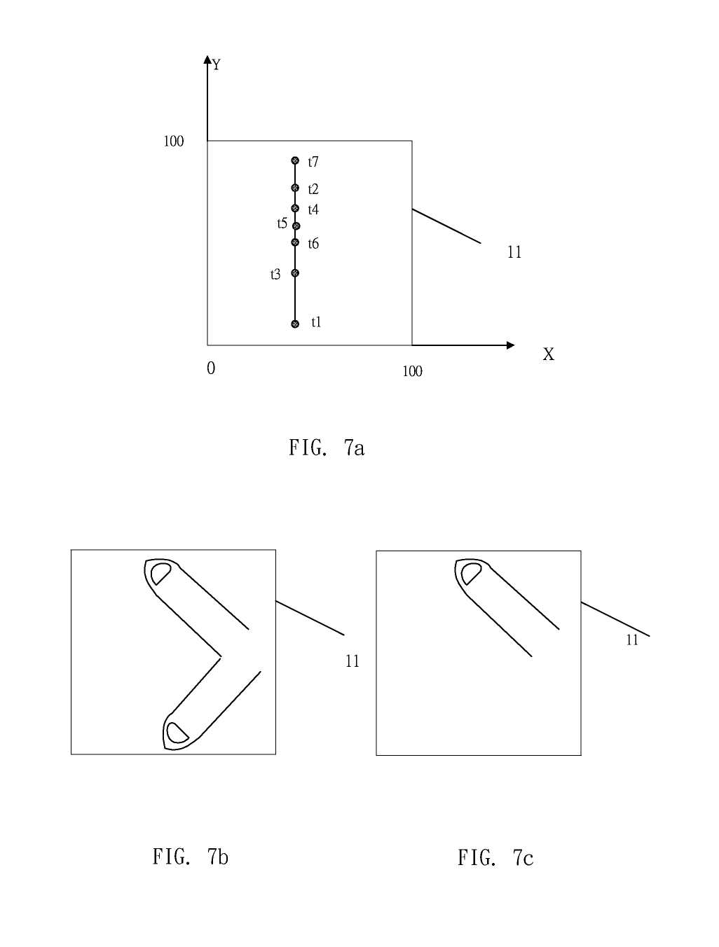

The table 6 above shows (x, y, A) values detected by the processor 13 within a predetermined time interval, (t1 through t6, t6 through t7) for example 6, and corresponding FIGS. 7a, 7b and 7c respectively shows the detected touch-point variation on the single-point detection panel 11 and the judgment result of processor 13 according to algorithm 15. In details, as the processor 13 detects the values in table 6 within the predetermined time interval (about 40-50 milli-sec), the processor 13 judges, during t1 to t6, it is a two-point touch and these two points are respectively at the terminals of the straight line or at an extension line of the straight line as shown in FIG. 7b, and judges as well, after the time interval (at and after t7), only one of these two points keeps on touching on the single-point detection panel 11 as shown in FIG. 7c. This is because the processor 13 detects the locations substantially varying along a straight line and the area parameter falls within the predetermined level range (for instance smaller than about 200) during the predetermined time interval (t1 to t6) indicating the touch action is a two-point touch action during the predetermined time interval. After the time interval (t1 to t6), the touch location is at one of the terminal of straight line, and the area parameter Ati falls out of the predetermined level range (for instance larger than about 200) indicating the touch action becomes a single-point touch and the location of single-point touch is (Xt7, Yt7). As a result, the processor 13 judges, during (t1 to t6) the touch action is a two-point touch and one of the two points is located at the terminal (Xt7, Yt7) of straight line region formed by all balanced locations, the other point is located at the other terminal (Xt1, Yt1) of the straight line region or it is located on an line extending outwardly from (Xt1, Yt1), and judges as well, after (t1 to t6), only one of these two points, i.e. (Xt7, Yt7), keeps on touching upon the single-point detection panel 11.

It is reemphasized here that under the situation of two-point touch action, since the location detected by the single-point detection panel 11 is a balanced location between two actual physical touch points. There are seven balanced locations in table 6. The distance of the balanced location away from these two actual physical touch points depend on the actual forces applied on the single-point detection panel 11 by the two actual physical touch points. As the forces exerted on the single-point detection panel 11 by two actual physical touch points are identical, the balanced location gets closer to a median location of two actual physical touch points. As the forces exerted on the single-point detection panel 11 by two actual physical touch points are far from identical, the balanced location will be much closer to one actual physical touch point having a larger force exertion, and will be much far away from another actual physical touch point having a smaller force exertion.

In addition, for the scenario that two locations are touched by a single touch action upon the single-point detection panel 11 at different occasions (not substantially simultaneously), at the moment the first actual touch point touches on single-point detection panel 11, the location detected by single-point detection panel 11 is the actual location of the first physical touch action, and at the moment the second actual touch point touches on the single-point detection panel 11, the location detected by the single-point detection panel 11 will be, however, a balanced location caused by the first actual touch point and the second actual touch point. As long as the forces exerted by the first actual touch point and the second actual touch point over the single-point detection panel 11 vary respectively, the detected balanced location will fluctuate between two actual locations of the first and second actual touch point. Under the scenario, the actual location of first actual touch point represents one terminal of above mentioned straight line region, and the actual location of second actual touch point is located on the line extending outward from the other terminal of the straight line. This is because that the other terminal of the straight line is a balanced location caused jointly by the first actual touch point (one terminal of the straight line region) and the second actual touch point. Hence, another terminal of the straight line is located between the first actual touch point (one terminal of the straight line region) and the second actual touch point, i.e., the second actual touch point is not within the straight line region formed by all balanced locations. Instead, the second actual touch point is on the extending line of the straight line region extending outward from the other terminal of the straight line region as recited above.

For the scenario that two actual touch points of single touch action contact with the single-point detection panel 11 about the same moment, all detected locations sensed by the single-point detection panel 11 are balanced locations caused jointly by two actual touch points and all balanced locations must be located between two actual touch points. Therefore the actual locations of two touch points are located respectively on two extension lines of the straight line region formed by all balanced locations. In example 6, it is known from above, after t7, the first actual touch point (Xt1, Yt1) disappears and only the second actual touch point (Xt7, Yt7) keeps on touching the single-point detection panel 11.

TABLE 7
(example 7)

| ti | t1 | t2 | t3 | t4 | t5 | . . . | tn |
|---|---|---|---|---|---|---|---|
| Xti | 73 | 62 | 50 | 39 | 26 | . . . | . . . |
| Yti | 26 | 38 | 50 | 62 | 74 | . . . | . . . |
| Ati | 160 | 158 | 159 | 163 | 162 | . . . | . . . |

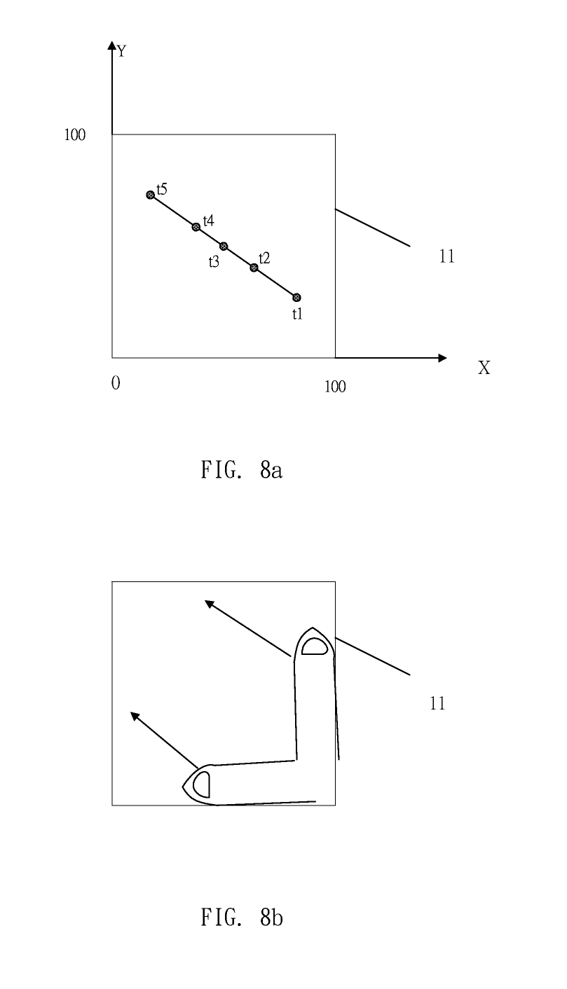

The table 7 above shows (x, y, A) values detected by the processor 13 within a predetermined time interval for example 7, and corresponding FIG. 8a, 8b respectively shows the detected touch-point variation on the single-point detection panel 11 and the judgment result of processor 13 according to algorithm 15. In details, as the processor 13 detects the values of table 7 during the predetermined time interval (about 40-50 milli-sec), the processor 13 judges this touch action is a two-point touch, the distance between two points is substantially unchanged and the two points substantially moves toward the same direction as shown in FIG. 8b. This is because the processor 13 detects at least one of X-axis coordinate value and Y-axis coordinate value of the touch points gradually increases or decreases during the predetermined time interval. In this example 7, X-axis coordinate values gradually decrease and Y-axis coordinate values gradually increase indicating during the predetermined time interval the two touch points substantially move toward the same direction. The detected area parameters Ati are substantially unchanged and falls within the predetermined level range (about smaller than 200) indicating during the predetermined time interval the touch action is a two-point touch and the corresponding distance between the points is substantially unchanged. Therefore, the processor 13 judges the touch action is a two-point touch, the distance between two points is substantially unchanged and two points substantially move toward the same direction substantially simultaneously.

From above disclosures for the embodiment of the invention, it is known the objectives are achieved and each judgment result can be used to activate a corresponding function of an apparatus which implements the touch panel system 10 and method disclosed.

To summarize for above descriptions to the touch panel system 10, it implements a method for detecting a single-point touch or a multiple-point touch action based on a single-point detection panel 11, wherein the single-point detection panel 11 outputting a signal 113 corresponding to a touch action 111. The method comprising:

processing the signal 113 to determine the detected location (x, y) of detection panel 11 on which the touch action is performed; and

according to an algorithm 15, detecting a variation of detected location within a predetermined time interval in order to judge whether the touch action 111 is a single-point touch or a multiple-point touch. Following the judgment result, a corresponding function is activated accordingly.

The detailed explanations for the operations of the method can be referred to the descriptions for the above seven examples with regard to the touch panel system 10 and are not repeated here again for brevity.

While the present invention has been shown and described with reference to the preferred embodiments thereof and in terms of the illustrative drawings, it should not be interpreted as limited thereby. Various possible modifications and alterations could be conceived of by one skilled in the art to the form and the content of any particular embodiment, without departing from the scope and the spirit of the present invention. Such modifications or alternations are also the scope the following claims intend to cover.

What is claimed is:

1. A touch panel system, comprising:
a single-point detection panel outputting a signal responsive to a touch action; and
a processor processing the signal for judging a location of the single-point detection panel on which the touch action is performed;
wherein the processor, based on an algorithm, detects a variation of the location within a predetermined time interval, to judge whether the touch action is a single-point touch or a multiple-point touch.

2. The touch panel system of claim 1, wherein the algorithm comprises: as the processor detects the location is substantially unchanged, the processor judges the touch action is a single-point touch.

3. The touch panel system of claim 1, wherein the algorithm comprises: as the processor detects the location is varying within a region, the processor judges the touch action is a multiple-point touch.

4. The touch panel system of claim 3, wherein the algorithm comprises: as the region is substantially a straight line, the processor judges the multiple-point touch indicates a two-point touch.

5. The touch panel system of claim 3, the algorithm comprises: as the region is substantially a polygon, the processor judges the multiple-point touch indicates at least a three-point touch.

6. The touch panel system of claim 1, wherein the algorithm comprises: the processor calculates a parameter based on the signal, the parameter corresponds to an area influenced by the touch action over the single-point detection panel, and determines whether the touch action is a single-point touch or a multiple-point touch based on the parameter calculated.

7. The touch panel system of claim 6, wherein the algorithm comprises: as the parameter falls within a predetermined level range, the processor judges the touch action is a multiple-point touch; otherwise the processor judges the touch action is a single-point touch.

8. The touch panel system of claim 7, wherein the algorithm comprises: as the processor detects the location is substantially varying within a straight line, and the parameter continuously falls within the predetermined level range, and the influenced area continuously increases, the processor judges the multiple-point touch is a two-point touch and the two points depart from each other gradually.

9. The touch panel system of claim 7, wherein the algorithm comprises: as the processor detects the location is substantially varying within a straight line, and the parameter continuously falls within the predetermined level range, and the influenced area continuously decreases, the processor judges the multiple-point touch is a two-point touch and the two points approach each other gradually.

10. The touch panel system of claim 7, wherein the algorithm comprises: as the processor detects the location is substantially varying within a straight line and the parameter continuously falls within the predetermined level range during the predetermined time interval, and, after the predetermined time interval, the detected location is located on a terminal of the straight line and the parameter falls out of the predetermined level range, the processor judges the touch action is a two-point touch and one of the two points is located on one of the terminals of the straight line, the other of the two points is located on the other terminal of the straight line or on an extension line of the straight line during the predetermined time interval, and judges only one of the two points keeps on touching upon the single-point detection panel after the predetermined time interval.

11. The touch panel system of claim 7, wherein the location is indicated by coordinate values along X-axis and Y-axis respectively, wherein the algorithm comprises: as the processor detects at least one of the coordinate values continuously increases or decreases, and the parameter is substantially unchanged and falls within the predetermined level range within the predetermined time interval, the processor judges the touch action is a two-point touch, a distance between the two points remains substantially unchanged and the two points substantially move toward the same direction simultaneously.

12. A method for detecting a single-point touch or a multiple-point touch based on a single-point detection panel, the single-point detection panel outputting a signal responsive to a touch action, the method comprising:
processing the signal to determine a location of the single-point detection panel on which the touch action is performed; and
detecting a variation of the location within a predetermined time interval, based on an algorithm, to judge whether the touch action is a single-point touch or a multiple-point touch.

13. The method of claim 12, wherein the algorithm comprises: as the location is detected to be substantially unchanged, the touch action is judged to be a single-point touch.

14. The method of claim 12, wherein the algorithm comprises: as the location is detected to be varying within a region, the touch action is judged to be a multiple-point touch.

15. The method of claim 14, wherein the algorithm comprises: as the region is substantially a straight line, the multiple-point touch is judged to be a two-point touch.

16. The method of claim 14, wherein the algorithm comprises: as the region is substantially a polygon, the multiple-point touch is judged to be at least a three-point touch.

17. The method of claim 12, wherein the algorithm comprises: a parameter is calculated based on the signal, the parameter corresponds to an area influenced by the touch action over the single-point detection panel, and it is judged whether the touch action is a single-point touch or a multiple-point touch based on the parameter.

18. The method of claim 17, wherein the algorithm comprises: as the parameter falls within a predetermined level range, the touch action is judged to be a multiple-point touch; otherwise the touch action is judged to be a single-point touch.

19. The method of claim 18, wherein the algorithm comprises: as the location is detected to be substantially varying within a straight line, and the parameter continuously falls within the predetermined level range, and the influenced area continuously increases, it is judged that the multiple-point touch is a two-point touch and the two points depart from each other gradually.

20. The method of claim 18, wherein the algorithm comprises: as the location is detected to be substantially varying within a straight line, and the parameter continuously falls within the predetermined level range, and the influenced area continuously decreases, it is judged that the multiple-point touch is a two-point touch and the two points approach each other gradually.

21. The method of claim 18, wherein the algorithm comprises: as the location is detected to be substantially varying within a straight line and the parameter continuously falls within the predetermined level range during the predetermined time interval, and, after the predetermined time interval, the detected location is located on a terminal of the straight line and the parameter falls out of the predetermined level range, it is judged that the touch action is a two-point touch and one of the two points is located on one of the terminals of the straight line, the other point is located on the other terminal of the straight line or on an extension line of the straight line during the predetermined time interval, and judges only one of the two points keeps on touching upon the single-point detection panel after the predetermined time interval.

22. The method of claim 18, wherein the location is indicated by coordinate values along X-axis and Y-axis respectively, wherein the algorithm comprises: as it is detected that at least one of the coordinate values continuously increases or decreases, and the parameter is substantially unchanged and falls within the predetermined level range within the predetermined time interval, it is judged that the touch action is a two-point touch, a distance between the two points remains substantially unchanged and the two points substantially move toward the same direction simultaneously.
